(19) United States
(12) Patent Application Publication
(10) Pub. No.: US 2026/0213092 A1
(43) Pub. Date: Jul. 23, 2026

(54) BUTTON APPARATUS AND ELECTRONIC DEVICE

(71) Applicant: AAC Microtech (Changzhou) Co., Ltd., Changzhou City (CN)

(72) Inventors: Dong Lu, Changzhou (CN); Changliang Wang, Changzhou (CN)

(21) Appl. No.: 19/333,415

(22) Filed: Sep. 19, 2025

Related U.S. Application Data
(63) Continuation of application No. PCT/CN2025/073535, filed on Jan. 21, 2025.

(51) Int. Cl. H01H 13/14

(52) U.S. Cl. CPC H01H 13/14; H01H 2215/052

(57) ABSTRACT

A button apparatus includes a keycap and a sensor assembly fixed to a back pressing surface of the keycap. The sensor assembly includes a pressing support sheet fixed on the back pressing surface of the keycap, sensors fixed on a side of the pressing support sheet away from the keycap, a lead-out soldering lug and a fixing soldering lug fixed on a side of the pressing support sheet away from the keycap, and a piezoelectric single crystal sheet fixed on a side of the fixing soldering lug away from the keycap; and orthographic projections of the sensors and the lead-out soldering lug towards the keycap completely fall into a range of the back pressing surface of the keycap. The button apparatus can provide enough pressing rigidity support for finger pressing, and bring rich local vibration feedback for fingers, thereby achieving a good user experience effect.

### TECHNICAL FIELD

The present disclosure relates to the technical field of buttons and, in particular, to a button apparatus and an electronic device.

### BACKGROUND

A touch button is a button technology for realizing corresponding control by sensing a pressing signal, and particularly is a technology for performing accurate detection by sensing a pressing position and pressing strength to realize accurate control.

In the related art, the existing physical button is mainly implemented by a button, a metal dome or snap dome, or the like. The function of the button is achieved mainly by pressing the snap dome to conduct a circuit, and hand feeling is realized through force feedback during deformation of the snap dome. The physical button has a single effect, cannot achieve special effects adaptive to special scenarios, and thus cannot provide prompts and feedback which are more direct and are favorable for a muscle memory for a user. However, when the button in the related art realizes local vibration of the button, a button feedback effect can be achieved only for a single scenario, so that both final effect achievement and user experience are poor.

Therefore, it is desirable to provide a new button apparatus to solve the above problems.

### SUMMARY

The present disclosure aims to provide a button apparatus which can provide enough pressing rigidity support for finger pressing and bring rich local vibration feedback for fingers.

In order to solve the above technical problem, in an aspect, an embodiment of the present disclosure provides a button apparatus. The button apparatus includes: a keycap and a sensor assembly fixed to a back pressing surface of the keycap. A front pressing surface of the keycap is configured to receive a pressing force, and the sensor assembly is configured to detect the pressing force. The sensor assembly includes a pressing support sheet fixed on the back pressing surface of the keycap, a plurality of sensors fixed on a side of the pressing support sheet away from the keycap, a lead-out soldering lug and a fixing soldering lug fixed on a side of the pressing support sheet away from the keycap, and a piezoelectric single crystal sheet fixed on a side of the fixing soldering lug away from the keycap. The plurality of sensors are arranged at intervals, and the lead-out soldering lug is located among the plurality of sensors. Orthographic projections of the plurality of sensors and the lead-out soldering lug towards the keycap completely fall into a range of the back pressing surface of the keycap.

As an improvement, the pressing support sheet has a rigidity value of 50-80 N/mm.

As an improvement, one sensor of the plurality of sensors includes a first sensor and a second sensor which are fixed on the side of the pressing support sheet away from the keycap at intervals, and orthographic projections of the first sensor and the second sensor towards the keycap are respectively located at two ends of the back pressing surface of the keycap.

As an improvement, the sensor is one of a resistive sensor, a piezoelectric sensor, a capacitive sensor, and an ionizing sensor.

As an improvement, two sides of the lead-out soldering lug are fixedly connected to the pressing support sheet and/or the piezoelectric single crystal sheet respectively in a glue bonding or laser welding manner.

As an improvement, the lead-out soldering lug is made of stainless steel, and the lead-out soldering lug has a thickness of 0.3-0.5 mm.

As an improvement, the fixing soldering lug includes a first fixing soldering lug and a second fixing soldering lug, the first fixing soldering lug and the second fixing soldering lug are fixed between the pressing support sheet and the piezoelectric single crystal sheet, the first fixing soldering lug and the second fixing soldering lug are spaced apart along a length direction of the keycap, and the lead-out soldering lug and the plurality of sensors are located between the first fixing soldering lug and the second fixing soldering lug.

As an improvement, the fixing soldering lug is made of stainless steel, and the fixing soldering lug has a thickness of 0.3-0.5 mm.

As an improvement, the piezoelectric single crystal sheet includes a substrate fixed on the side of the fixing soldering lug away from the keycap and a piezoelectric ceramic sheet fixed on a side of the substrate away from the keycap, a side of the lead-out soldering lug away from the keycap abuts against the substrate, and a side of the sensor away from the keycap is spaced apart from the substrate.

As an improvement, a length of the substrate is greater than a length of the piezoelectric ceramic sheet, and the piezoelectric ceramic sheet directly faces the keycap.

As an improvement, the substrate is made of stainless steel or beryllium bronze, and the substrate is has a thickness of 0.1-0.5 mm.

As an improvement, the piezoelectric ceramic sheet is in a piezoelectric layer stack structure, and the piezoelectric layer stack structure has 3-20 layers.

In another aspect, an embodiment of the present disclosure provides an electronic device, including a shell and the above button apparatus fixed on a periphery of the shell, in which the shell includes a housing with an accommodating space and a through groove penetrating through a periphery of the housing; the keycap is arranged in the through groove, a side of the sensor assembly adjacent to the keycap is fixed on an inner wall of the housing, and the keycap is exposed outside the housing or is flush with the housing.

Compared with the related art, in the button apparatus according to the present disclosure, the sensor assembly is fixed on the keycap, the front pressing surface of the keycap is configured to receive the pressing force, and the sensor assembly is configured to detect the pressing force; the sensor assembly includes the pressing support sheet fixed on the back pressing surface of the keycap, the plurality of sensors fixed on the side of the pressing support sheet away from the keycap, the lead-out soldering lug and the fixing soldering lug fixed on the side of the pressing support sheet away from the keycap, and the piezoelectric single crystal sheet fixed on the side of the fixing soldering lug away from the keycap; the plurality of sensors are arranged at intervals, and the lead-out soldering lug is located among the plurality of sensors; the orthographic projections of the plurality of sensors and the lead-out soldering lug towards the keycap completely fall into the range of the back pressing surface of the keycap; the keycap is pressed to press the pressing support sheet, a pressing action of hands is detected by the sensor mounted on the pressing support sheet, the piezoelectric single crystal sheet is pressed by the lead-out soldering lug, and a corresponding acting force is fed back to the pressing support sheet; therefore, a button can provide enough pressing rigidity support for finger pressing, and bring rich local vibration feedback for the fingers, thereby improving a user experience effect.

### BRIEF DESCRIPTION OF DRAWINGS

To better describe the technical solutions in embodiments of the present disclosure, the following briefly describes the accompanying drawings required for the description of the embodiments. Accompanying drawings in the following description show merely some embodiments of the present disclosure, and a person of ordinary skill in the art may still derive other drawings from these accompanying drawings. In the drawings:

FIG. 1 is a schematic structural diagram of an electronic device according to an embodiment of the present disclosure;

FIG. 2 is a schematic exploded diagram of a housing and a button apparatus of the electronic device according to an embodiment of the present disclosure;

FIG. 3 is a schematic structural diagram of a button apparatus according to an embodiment of the present disclosure;

FIG. 4 is an exploded structural view of a button apparatus according to an embodiment of the present disclosure;

FIG. 5 is a sectional view taken along line A-A in FIG. 1; and

FIG. 6 is a partial enlarged view of part B in FIG. 5.

In the drawings, 100: button apparatus; 1: keycap; 2: sensor assembly; 21: pressing support sheet; 22: sensor; 221: first sensor; 222: second sensor; 23: lead-out soldering lug; 24: fixing soldering lug; 241: first fixing soldering lug; 242: second fixing soldering lug; 25: piezoelectric single crystal sheet; 251: substrate; 252: piezoelectric ceramic sheet; 200: electronic device; 201: shell; 2011: housing; 2012: through groove.

### DESCRIPTION OF EMBODIMENTS

The technical solutions in the embodiments of the present disclosure are clearly and completely described with reference to the accompanying drawings in the embodiments of the present disclosure, and the described embodiments are not all but only a part of the embodiments of the present disclosure. All other embodiments obtained by a person of ordinary skill in the art based on the embodiments of the present disclosure shall fall within the protection scope of the present disclosure.

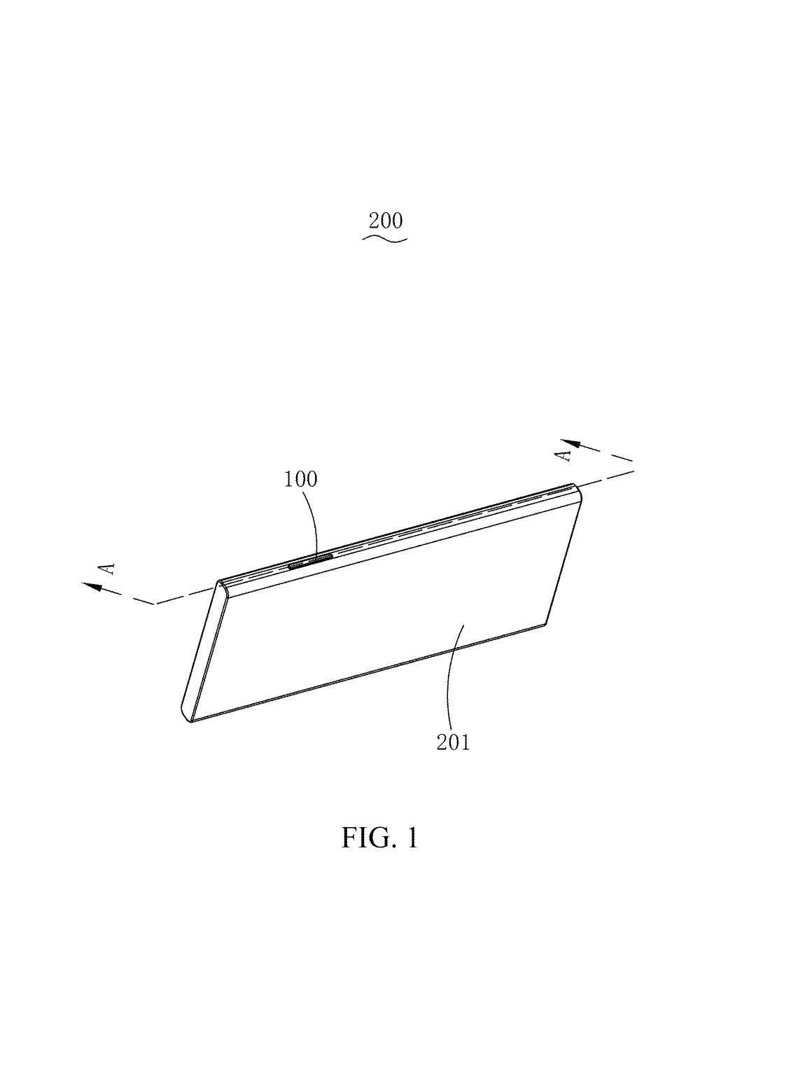

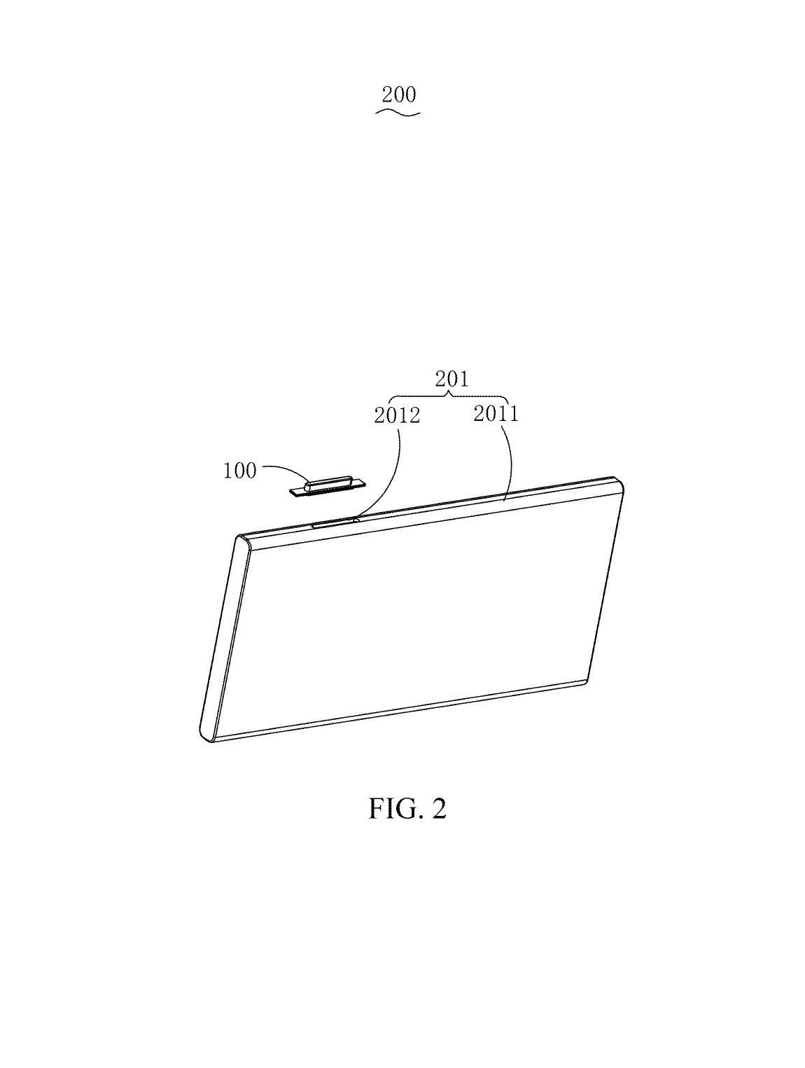

Referring to FIG. 1 to FIG. 2, an embodiment of the present disclosure provides an electronic device 200. The electronic device 200 includes a shell 201 and a button apparatus 100 fixed on a periphery of the shell 201. The shell 201 includes a housing 2011 with an accommodating space and a through groove 2012 penetrating through a periphery of the housing 2011. A keycap 1 is arranged in the through groove 2012, a side of a sensor assembly 2 adjacent to the keycap 1 is fixed on an inner wall of the housing 2011, and the keycap 1 is exposed outside the housing or is flush with the housing 2011. By pressing the button apparatus 100 in the shell 201, the keycap 1 can provide enough pressing rigidity support for finger pressing, and bring rich local vibration feedback for fingers, thereby improving a user experience effect.

Optionally, the electronic device 200 may be a device requiring a button operation, such as a mobile phone, a tablet, a headset, a handle, a steering wheel and a tablet.

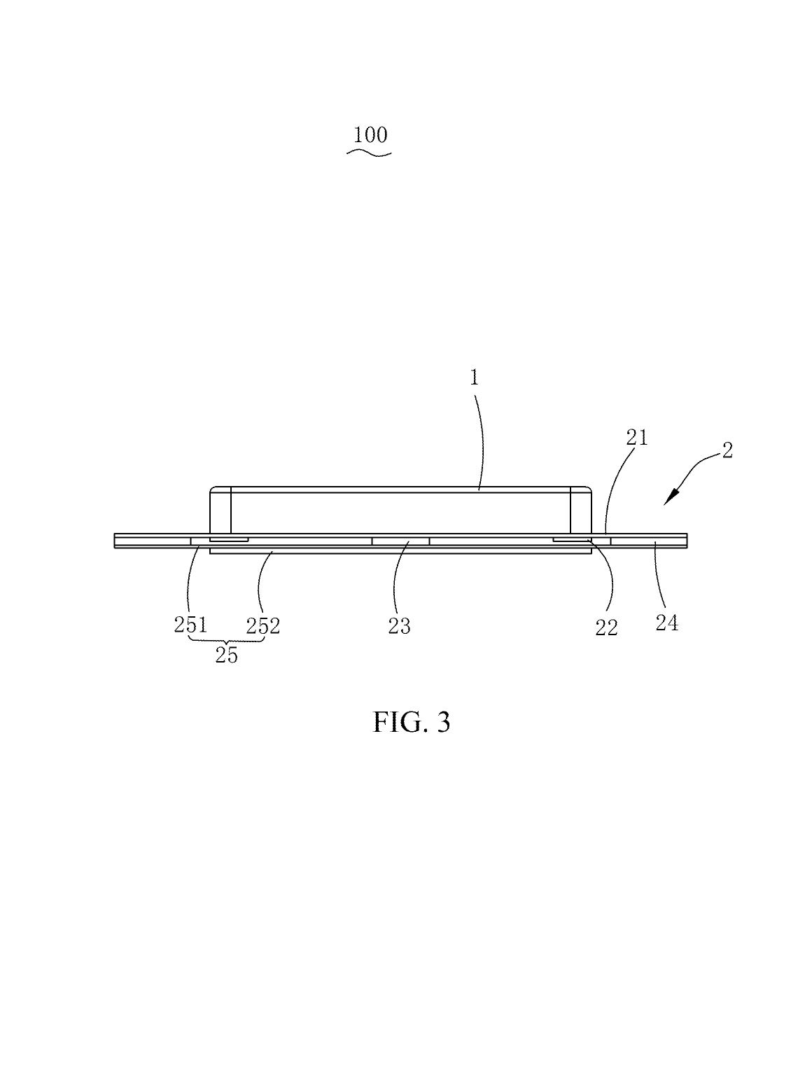

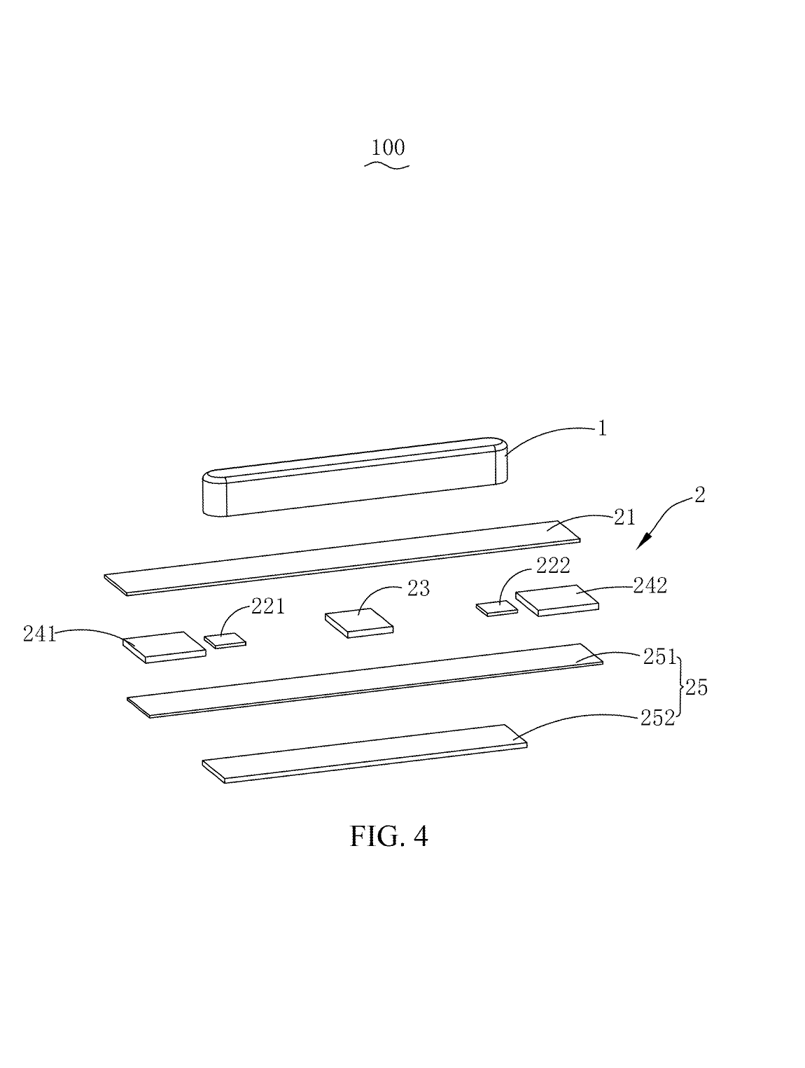

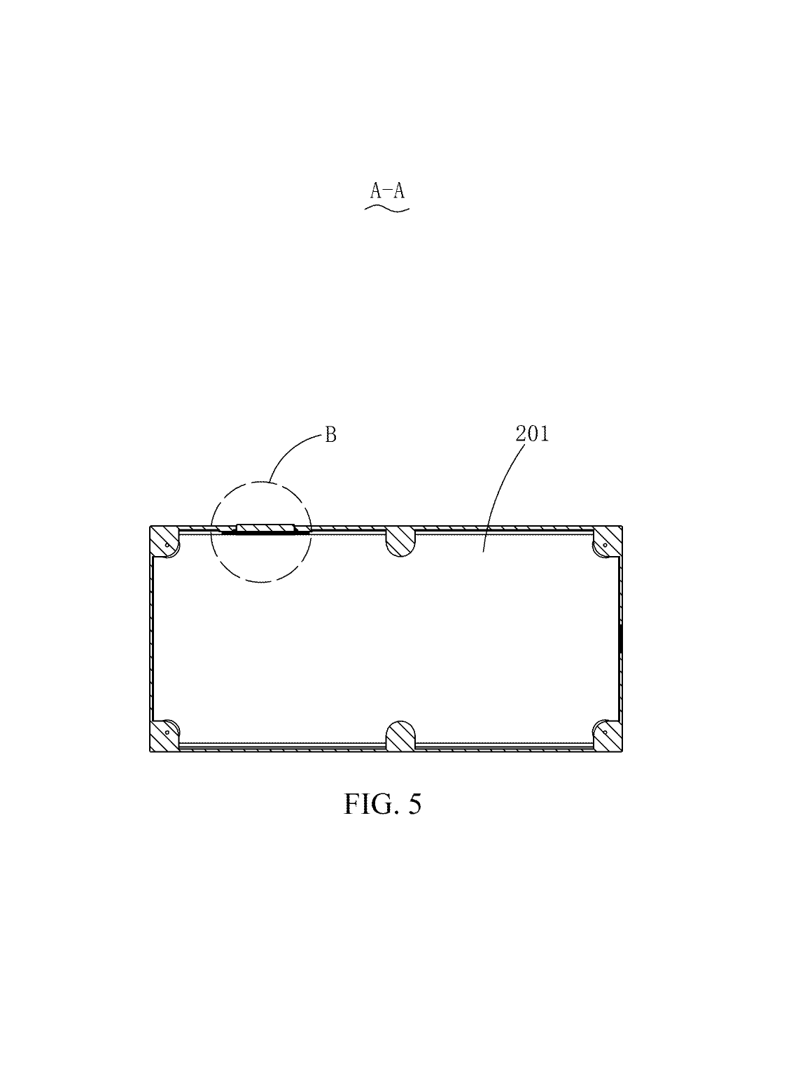

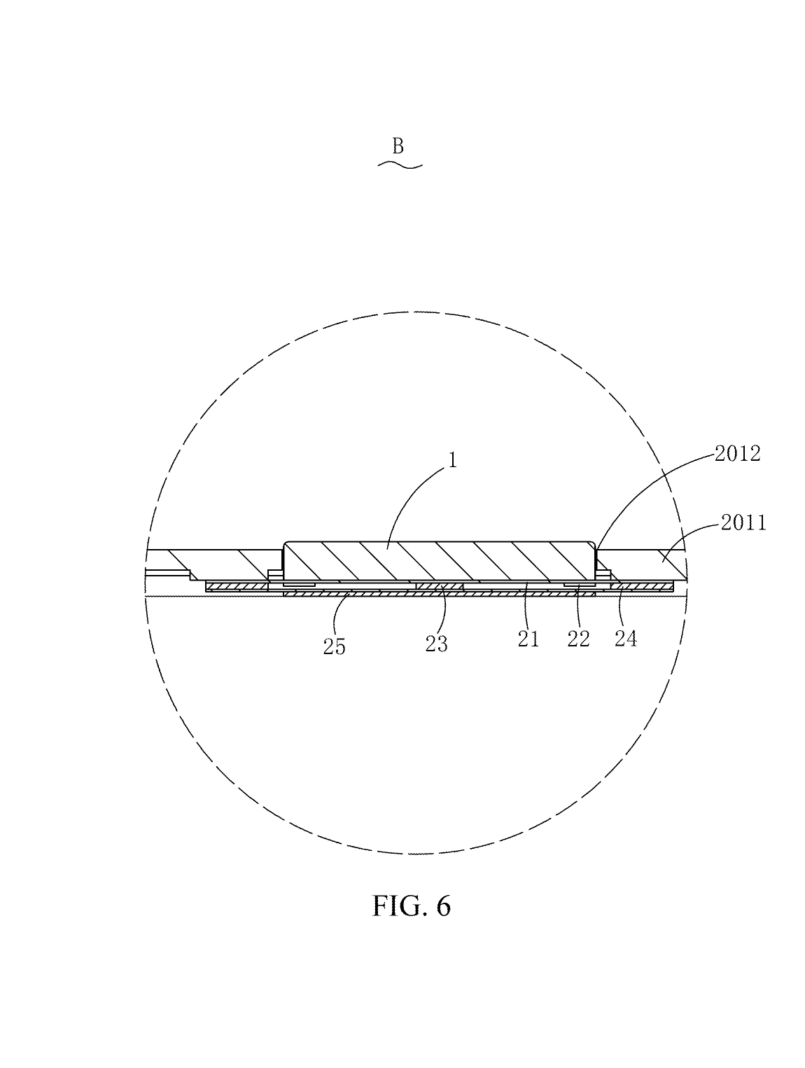

Referring to FIG. 3 to FIG. 6, an optional embodiment of the present disclosure provides a button apparatus 100, including a keycap 1 and a sensor assembly 2 fixed to a back pressing surface of the keycap 1, in which a front pressing surface of the keycap 1 is configured to receive a pressing force, and the sensor assembly 2 is configured to detect the pressing force. Optionally, the whole keycap 1 is of an annular structure, so that mounting is convenient, and a pressing effect is good.

The sensor assembly 2 includes a pressing support sheet 21 fixed on the back pressing surface of the keycap 1, a plurality of sensors 22 fixed on a side of the pressing support sheet 21 away from the keycap 1, a lead-out soldering lug 23 and a fixing soldering lug 24 fixed on a side of the pressing support sheet 21 away from the keycap 1, and a piezoelectric single crystal sheet 25 fixed on a side of the fixing soldering lug 24 away from the keycap 1; the plurality of sensors 22 are arranged at intervals, and the lead-out soldering lug 23 is located among the plurality of sensors 22; and orthographic projections of the plurality of sensors 22 and the lead-out soldering lug 23 towards the keycap 1 completely fall into a range of the back pressing surface of the keycap 1. The sensor 22, the lead-out soldering lug 23 and the fixing soldering lug 24 are arranged at intervals. The keycap 1 is pressed to press the pressing support sheet 21, a pressing action of hands is detected by the sensor 22 mounted on the pressing support sheet 21, the piezoelectric single crystal sheet 25 is pressed by the lead-out soldering lug 23, and a corresponding acting force is fed back to the pressing support sheet 21; therefore, the button can provide enough pressing rigidity support for finger pressing, and bring rich local vibration feedback for fingers, thereby improving a user experience effect.

In an embodiment, a rigidity value of the pressing support sheet 21 is 50-80 N/mm. Rigidity support is provided by the pressing support sheet 21 when the finger presses a side key, a material is stainless steel, and the rigidity value of the pressing support sheet 21 is 50~80 N/mm, so that the pressing support sheet 21 has a good support effect.

In an embodiment, the plurality of sensors 22 include a first sensor 221 and a second sensor 222 which are fixed on the side of the pressing support sheet 21 away from the keycap 1 at intervals, and orthographic projections of the first sensor 221 and the second sensor 222 towards the keycap 1 are respectively located at two ends of the back pressing surface of the keycap 1. The first sensor 221 and the second sensor 222 are respectively mounted on two opposite ends of the pressing support sheet 21 corresponding to the keycap 1, so that the first sensor 221 and the second sensor 222 can detect pressing forces of the finger, and meanwhile can detect sliding pressing, or the like, of the finger, thereby enriching the detection effect on pressing behaviors of the finger.

In an embodiment, the sensor 22 and the pressing support sheet 21 are fixedly connected in a glue bonding or laser welding manner. Assembling is convenient, and a fixing effect is good.

In an embodiment, the sensor 22 is one of a resistive sensor 22, a piezoelectric sensor 22, a capacitive sensor 22, and an ionizing sensor 22. The resistive sensor 22 is configured to convert a pressure physical quantity into a change of a resistance value, and has high detection accuracy. The piezoelectric sensor 22 is a sensor 22 based on piezoelectric effect, a sensitive element thereof is made of a piezoelectric material, and the piezoelectric sensor 22 is configured to measure a force and a non-electrical physical quantity which can be converted into electricity. The capacitive sensor 22 is a conversion apparatus that takes various types of capacitors as sensing elements and converts a measured physical quantity or mechanical quantity into a capacitance change, and is actually a capacitor with variable parameters. The ionizing sensor 22 is a sensor 22 for converting a measured change into a change of an ionization current.

In an embodiment, two sides of the lead-out soldering lug 23 are fixedly connected to the pressing support sheet 21 and/or the piezoelectric single crystal sheet 25 respectively in a glue bonding or laser welding manner. Therefore, the lead-out soldering lug 23, the pressing support sheet 21 and the piezoelectric single crystal sheet 25 have a good fixing effect. The lead-out soldering lug 23 is connected to the piezoelectric single crystal sheet 25 and the pressing support sheet 21, and transmits bending vibration of the piezoelectric single crystal sheet 25 to the keycap 1.

In an embodiment, the lead-out soldering lug 23 is made of stainless steel, and a thickness of the lead-out soldering lug 23 is 0.3-0.5 mm. The stainless steel has high structural strength and a good support effect. Meanwhile, a thickness is small, and a cost and a mounting space are saved.

In an embodiment, the fixing soldering lug 24 includes a first fixing soldering lug 241 and a second fixing soldering lug 242, the first fixing soldering lug 241 and the second fixing soldering lug 242 are fixed between the pressing support sheet 21 and the piezoelectric single crystal sheet 25, and the first fixing soldering lug 241 and the second fixing soldering lug 242 are spaced apart along a length direction of the keycap 1, so as to achieve the fixing effect of connecting the piezoelectric single crystal sheet 25 and the pressing support sheet 21. The lead-out soldering lug 23 and the plurality of sensors 22 are located between the first fixing soldering lug 241 and the second fixing soldering lug 242. Meanwhile, the keycap 1 is located between the first fixing soldering lug 241 and the second fixing soldering lug 242, and when the keycap 1 is pressed, a good elastic feedback performance can be provided by the pressing support sheet 21, thereby further improving vibration feedback.

In an embodiment, two sides of the fixing soldering lug 24 are fixedly connected to the pressing support sheet 21 and the piezoelectric single crystal sheet 25 respectively in a glue bonding or laser welding manner. Therefore, the fixing soldering lug 24, the pressing support sheet 21 and the piezoelectric single crystal sheet 25 have a good fixing effect, and meanwhile assembling is convenient.

In an embodiment, the fixing soldering lug 24 is made of stainless steel, and a thickness of the fixing soldering lug 24 is 0.3-0.5 mm. The stainless steel has high structural strength; meanwhile, a thickness is small, and a cost and a mounting space are saved.

In an embodiment, the piezoelectric single crystal sheet 25 includes a substrate 251 fixed on the side of the fixing soldering lug 24 away from the keycap 1 and a piezoelectric ceramic sheet 252 fixed on a side of the substrate 251 away from the keycap 1, a side of the lead-out soldering lug 23 away from the keycap 1 abuts against the substrate 251, and a side of the sensor 22 away from the keycap 1 is spaced apart from the substrate 251. The substrate 251 is configured to mount and fix the fixing soldering lug 24 and the pressing support sheet 21, and piezoelectric ceramic is an informational function ceramic material which can convert mechanical energy into electric energy and vice versa, and has piezoelectric effect and a sensitive characteristic, so that the experience effect of the button apparatus 100 is better.

In an embodiment, a length of the substrate 251 is greater than a length of the piezoelectric ceramic sheet 252, and the piezoelectric ceramic sheet 252 directly faces the keycap 1. Further, through holes can be further formed through two ends of the substrate 251, and the piezoelectric ceramic sheet 252 is located between the through holes and directly faces the keycap 1. The through holes facilitate fixed mounting of the substrate 251 to the housing 2011 of the electronic device 200 through bolts.

In an embodiment, the substrate 251 is made of stainless steel or beryllium bronze, and a thickness of the substrate 251 is 0.1-0.5 mm. The stainless steel has high structural strength; meanwhile, a thickness is small, and a cost and a mounting space are saved.

In an embodiment, the piezoelectric ceramic sheet 252 is in a piezoelectric layer stack structure, and the piezoelectric layer stack structure has 3-20 layers. The piezoelectric layer stack structure has a good piezoelectric performance.

Compared with the related art, in the button apparatus according to the present disclosure, the sensor assembly is fixed on the keycap, the front pressing surface of the keycap is configured to receive the pressing force, and the sensor assembly is configured to detect the pressing force; the sensor assembly includes the pressing support sheet fixed on the back pressing surface of the keycap, the plurality of sensors fixed on the side of the pressing support sheet away from the keycap, the lead-out soldering lug and the fixing soldering lug fixed on the side of the pressing support sheet away from the keycap, and the piezoelectric single crystal sheet fixed on the side of the fixing soldering lug away from the keycap; the plurality of sensors are arranged at intervals, and the lead-out soldering lug is located among the plurality of sensors; the orthographic projections of the plurality of sensors and the lead-out soldering lug towards the keycap completely fall into the range of the back pressing surface of the keycap; the keycap is pressed to press the pressing support sheet, the pressing action of the hands is detected by the sensor mounted on the pressing support sheet, the piezoelectric single crystal sheet is pressed by the lead-out soldering lug, and the corresponding acting force is fed back to the pressing support sheet; therefore, the button can provide enough pressing rigidity support for finger pressing, and bring rich local vibration feedback for the fingers, thereby improving the user experience effect.

The above description is only embodiments of the present disclosure, and it should be noted that improvements can be made by those of ordinary skill in the art without departing from the concept of the present disclosure, and all fall within the protection scope of the present disclosure.

What is claimed is:

1. A button apparatus, comprising a keycap and a sensor assembly fixed to a back pressing surface of the keycap,
wherein a front pressing surface of the keycap is configured to receive a pressing force, and the sensor assembly is configured to detect the pressing force;
wherein the sensor assembly comprises a pressing support sheet fixed on the back pressing surface of the keycap, a plurality of sensors fixed on a side of the pressing support sheet away from the keycap, a lead-out soldering lug and a fixing soldering lug fixed on a side of the pressing support sheet away from the keycap, and a piezoelectric single crystal sheet fixed on a side of the fixing soldering lug away from the keycap; the plurality of sensors is arranged at intervals, and the lead-out soldering lug is located among the plurality of sensors; and orthographic projections of the plurality of sensors and the lead-out soldering lug towards the keycap completely fall into a range of the back pressing surface of the keycap; and
wherein the plurality of sensors comprises a first sensor and a second sensor which are fixed on the side of the pressing support sheet away from the keycap at intervals, and orthographic projections of the first sensor and the second sensor towards the keycap are respectively located at two ends of the back pressing surface of the keycap.

2. The button apparatus as described in claim 1, wherein the pressing support sheet has a rigidity value of 50-80 N/mm.

3. The button apparatus as described in claim 1, wherein one sensor of the plurality of sensors is one of a resistive sensor, a piezoelectric sensor, a capacitive sensor, and an ionizing sensor.

4. The button apparatus as described in claim 1, wherein two sides of the lead-out soldering lug are fixedly connected to the pressing support sheet and/or the piezoelectric single crystal sheet respectively in a glue bonding or laser welding manner.

5. The button apparatus as described in claim 1, wherein the lead-out soldering lug is made of stainless steel, and the lead-out soldering lug has a thickness of 0.3-0.5 mm.

6. The button apparatus as described in claim 1, wherein the fixing soldering lug comprises a first fixing soldering lug and a second fixing soldering lug, the first fixing soldering lug and the second fixing soldering lug are fixed between the pressing support sheet and the piezoelectric single crystal sheet, the first fixing soldering lug and the second fixing soldering lug are spaced apart along a length direction of the keycap, and the lead-out soldering lug and the plurality of sensors are located between the first fixing soldering lug and the second fixing soldering lug.

7. The button apparatus as described in claim 6, wherein the fixing soldering lug is made of stainless steel, and the fixing soldering lug has a thickness of 0.3-0.5 mm.

8. The button apparatus as described in claim 1, wherein the piezoelectric single crystal sheet comprises a substrate fixed on the side of the fixing soldering lug away from the keycap and a piezoelectric ceramic sheet fixed on a side of the substrate away from the keycap, a side of the lead-out soldering lug away from the keycap abuts against the substrate, and a side of the sensor away from the keycap is spaced apart from the substrate.

9. The button apparatus as described in claim 8, wherein a length of the substrate is greater than a length of the piezoelectric ceramic sheet, and the piezoelectric ceramic sheet directly faces the keycap.

10. The button apparatus as described in claim 8, wherein the substrate is made of stainless steel or beryllium bronze, and the substrate has a thickness of 0.1-0.5 mm.

11. The button apparatus as described in claim 8, wherein the piezoelectric ceramic sheet is in a piezoelectric layer stack structure, and the piezoelectric layer stack structure has 3-20 layers.

12. An electronic device, comprising a shell and a button apparatus fixed on a periphery of the shell,
wherein the shell comprises a housing with an accommodating space and a through groove penetrating through a periphery of the housing, the keycap is arranged in the through groove, a side of the sensor assembly adjacent to the keycap is fixed on an inner wall of the housing, and the keycap is exposed outside the housing or is flush with the housing;
wherein the button apparatus comprises a keycap and a sensor assembly fixed to a back pressing surface of the keycap;
wherein a front pressing surface of the keycap is configured to receive a pressing force, and the sensor assembly is configured to detect the pressing force;
wherein the sensor assembly comprises a pressing support sheet fixed on the back pressing surface of the keycap, a plurality of sensors fixed on a side of the pressing support sheet away from the keycap, a lead-out soldering lug and a fixing soldering lug fixed on a side of the pressing support sheet away from the keycap, and a piezoelectric single crystal sheet fixed on a side of the fixing soldering lug away from the keycap; the plurality of sensors is arranged at intervals, and the lead-out soldering lug is located among the plurality of sensors; and orthographic projections of the plurality of sensors and the lead-out soldering lug towards the keycap completely fall into a range of the back pressing surface of the keycap; and
wherein the plurality of sensors comprises a first sensor and a second sensor which are fixed on the side of the pressing support sheet away from the keycap at intervals, and orthographic projections of the first sensor and the second sensor towards the keycap are respectively located at two ends of the back pressing surface of the keycap.
